(19) United States
(12) Patent Application Publication
(10) Pub. No.: US 2004/0099772 A1
(43) Pub. Date: May 27, 2004

(54) Holding element for tubular objects

(76) Inventors: Markus Durig, Feldkirch (AT); Mariana Maglione, Buchs (CH); Remo Kluser, Hinterforst (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/715,759

(22) Filed: Nov. 18, 2003

(30) Foreign Application Priority Data
Nov. 19, 2002 (DE) 102 53 996.0

(51) Int. Cl. F16L 3/22

(52) U.S. Cl. 248/68.1; 248/71; 248/547

(57) ABSTRACT

A holding element for tubular objects has a holding member (11); and an attachment member (20) with an abutment (22) for a fastening element (30), which extends through a through-opening (21) formed in the attachment member (20), with the attachment member (20) further including at least two spring shackles (23, 24) provided sidewise of the abutment (22) and each having a retaining section (28) provided on its outer surface for friction-lockingly and/or force-lockingly temporary securing the holding element (10) on a bolt guide (40) of a setting tool.

### BACKGROUND OF THE INVENTION

1. Field of the Invention

The present invention relates to a holding element for tubular objects such as tubular conduits, cable bundles, cable guides and the like and including a holding member having a through-opening through which a fastening element is extendable, and an abutment for the fastening element.

2. Description of the Prior Art

German Publication DE 25 04 816 A1 discloses a holding element of the type discussed above with which a fastening element such as a nail is provided on the holding element before the setting process. The holding element is then secured with the nail, which is provided with a guide member that is inserted in the bolt guide, until the holding element is secured to the bolt guide.

The drawback of the holding element of DE-25 04 816 A1 consists in that nail magazines cannot be used because when a nail magazine is used, the holding element cannot be secured to the bolt guide, and this makes the setting process more difficult. However, it is desirable to use nail magazines because the combination fastening element/holding element becomes more effective.

German Publication DE-295 10 892 U1 discloses a holding element of the above-discussed type in which the attachment member has an elevation that serves for clamping of the holding element on the bolt guide. The drawback of this holding element consist in that the elevation permits to pin the holding element only on a bolt guide having a predetermined outer diameter, and it is not possible to use the holding element with setting tools having different diameters of the bolt guides.

Accordingly, an object to the present invention is to provide a holding element of a type discussed above in which the foregoing drawbacks are eliminated and which can be used with different types of setting tools.

Another object of the present invention is a holding element of the above-discussed type which can be easily manufactured.

### SUMMARY OF THE INVENTION

These and other objects of the present invention, which will become apparent hereinafter, are achieved by providing a holding element in which the attachment member further includes at least two spring shackles. provided sidewise of the abutment, with the spring shackles each having a retaining section provided on its outer surface for friction-lockingly and/or force-lockingly temporary securing the holding element on a bolt guide of a setting tool.

By providing, on the attachment member sidewise of the through-opening for a fastening element, at least two spring shackles (tongues) which are insertable in a bolt guide of a setting tool and which are provided on their outer sides remote from the through-opening with retaining sections, a friction and/or force-locking temporary fixing of the holding element in the bolt guide became possible. With the attachment member having spring shackles having a predetermined excursion, the inventive holding element can be advantageously secured on bolt guides having different diameters. Thus, the holding element needs not be pre-assembled together with the fastening elements.

Advantageously, the spring shackles or tongues project from the attachment member of the holding element in the insertion direction of the holding element. This permits to compress the ends of he shackles, which are inserted in a bolt guide, to a minimal distance or spread them from each other as far as possible, so that they can be inserted in bolt guides having. a large inner diameter and in bolt guides having a small inner diameter. Their flexibility can be further increased by forming the projecting tongues or shackles as pincers.

Forming the spring shackles as elongate curved elements with a concave surface facing the attachment axis increases the resiliency of the shackles or tongues and facilitates insertion of the tongues into a bolt guide. The curvature can be continuous in form of an arch or discontinuous with separate surfaces being bent toward each other.

The manufacturing of the holding element is simplified when the spring shackles or tongues are produced by partially punching them out or cutting them out of a wall section of the attachment member adjacent to the through-opening.

Advantageously, the holding element is produced of metal as a stamped bent part or of plastic material as an injection-molded part.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a perspective view of a holding element for tubular objects according to the present invention;

FIG. 2 a cross-sectional view along line II-II in FIG. 1 of the holding element arranged on al bolt guide of a setting tool; and

FIG. 3 a detail III in FIG. 2 of the holding element at an increased, in comparison with FIG. 2, scale but without the bolt guide.

### DETAILED DESCRIPTION OF THE PREFERRED EMBODIMENTS

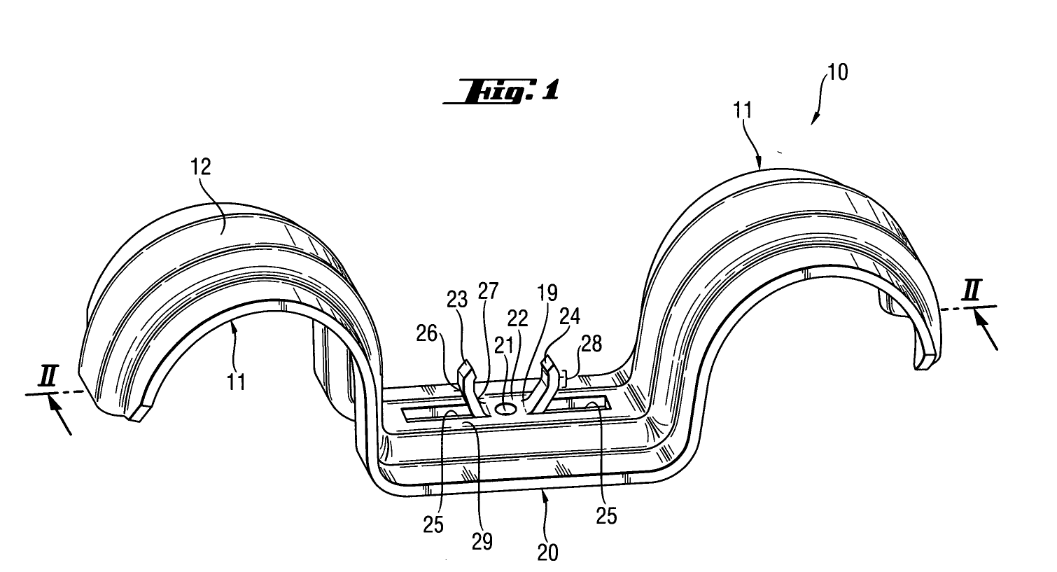

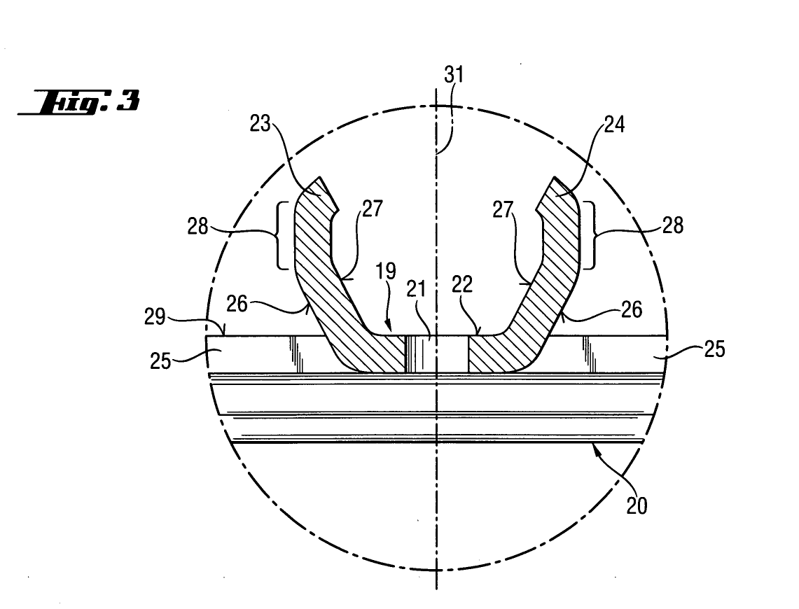

A holding element 10 according to the present invention, which is shown in FIGS. 1-3, includes a holding member 11 and an attachment member 20. The holding member 11 is formed as a semi-circular part designed for embracing of round tubular conduit. The holding member 11 is formed of sheet metal and is provided with a reinforcement stiffening element 12. The stiffening element 12 extends along both holding members 11 and the attachment member 20.

The attachment member 20 has a through-opening 21 for a fastening element 30 such as nail, bolt, etc. The through-opening 21 is surrounded with an abutment 22 for the fastening element. When the holding element 10 is secured with the fastening element 30 to a constructional component or a substate, the head of the fastening element 30 is supported on the abutment 22.

Sidewise of the abutment, two spring shackles 23, 24 are provided on the attachment member 20. The spring shackles 23, 24 project from the attachment member 20 upward in direction 41. The spring shackles 23, 24 are slightly bent toward each other, i.e., in the direction toward the attachment axis 31, so that the outer surface 26 of the spring shackles 23, 24 has a somewhat convex shape, and the inner surface 27 has a somewhat concave shape. Concave or convex here does not mean that the surfaces 26, 27 have a continuous curved shape. Rather, the surfaces have a discontinuous shape which is formed by following each other and bent toward each other surfaces. The bent surfaces insure an easy insertion of the spring shackles in a bolt guide 40 of a setting tool. Further, the bent surfaces insure a good resiliency of the spring shackles 23, 24, which insure insertion and temporary attachment of the holding element 10 in bolt guides 40 with different inner diameters.

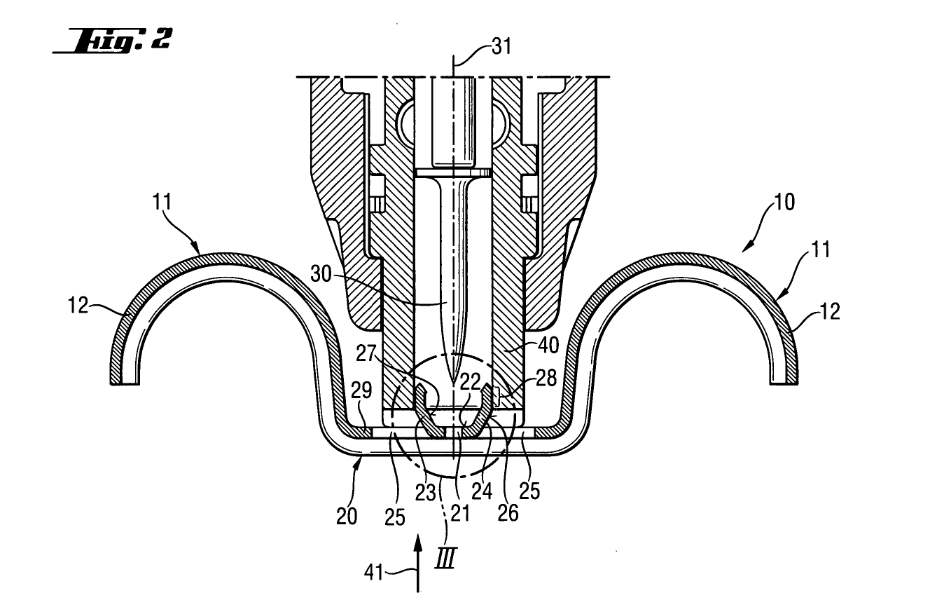

The attachment is effected with remaining sections 28 formed on outer surfaces 26 of the spring shackles 23, 24.and which are pressed, in an inserted condition of the holding element 10 into the bolt guide 40 (See FIG. 2), by the biasing force of the spring shackles 23, 24 against the inner wall of the bolt guide 40. The friction forces provide for retaining of the holding element 10 on the bolt guide 40.

During the manufacturing of the holding element 10, the spring shackles 23, 24 can be produced by punching out openings 25 in a wall section 29 of the attachment member 20, with a material bridge 19, which connects the two openings, forming the abutment 22. The spring shackles 23, 24 are produced by bending out the punched-out material in the direction 41. The curvature of the shackles is produced in the following step.

The holding element 10 can also be produced from other than metal materials e.g., from steel. The holding element 10 can have only one retaining member 11 instead of two shown in the drawings. Also, the attachment member 20 and the holding members 11 can be formed not, as a single part but rather as a multi-part.

Though the present invention was shown and described with references to the preferred embodiment such is merely illustrative of the present invention and are not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A holding element for tubular objects comprising a holding member (11); and an attachment member (20) having a through-opening (21) through which a fastening element (30) is extendable, and an abutment (22) for the fastening element (30), the attachment member (20) further including at least two spring shackles (23, 24) provided sidewise of the abutment (22), the spring shackles (23, 24) each having a retaining section (28) provided on an outer surface (26) thereof for at least one of friction-lockingly and force-lockingly temporary securing the holding element (10) on a holt guide (40) of a setting tool.

2. A holding element according to claim 1, wherein the spring shackles (23, 24) project from the attachment member (20) in an insertion direction (41 of the holding element (10).

3. A holding element according to claim 1, wherein the spring shackles (23, 24) are located opposite each other and are formed as pincers.

4. A holding element according to claim 1, wherein the spring shackles (23, 24) are formed as elongate curved elements an outer surface (26) of which is, at least regionwise, convexly shaped and an inner surface (27) of which is, at least regionwise, concavely shaped.

5. A holding element according to claim 1, wherein the spring shackles (23, 24) are formed of a material of a wall section (29) of the attachment member (20) by being bent out therefrom.

6. A holding element according to claim 1, wherein the holding element (10) is formed of metal as stamped bent part.

7. A holding element according to claim 1, wherein the holding element (10) is formed of a plastic material as an injection-molded part.
